(19) United States
(12) Patent Application Publication
(10) Pub. No.: US 2023/0036113 A1
(43) Pub. Date: Feb. 2, 2023

(54) DATA PROCESSING DEVICE, DATA PROCESSING METHOD, AND PROGRAM

(71) Applicant: FUJIFILM CORPORATION, Minato-ku, Tokyo (JP)

(72) Inventor: Eiichiro KATAOKA, Kanagawa (JP)

(21) Appl. No.: 17/814,837

(22) Filed: Jul. 26, 2022

(30) Foreign Application Priority Data
Jul. 29, 2021 (JP) 2021-124747

(51) Int. Cl. G06F 3/06

(52) U.S. Cl. CPC G06F 3/0655; G06F 3/0679; G06F 3/0604

(57) ABSTRACT

A data processing device includes a processor, and a storage connected to the processor. The processor acquires industrial data, stores the acquired industrial data in the storage, causes a magnetic tape management system that manages a magnetic tape to save the industrial data stored in the storage on the magnetic tape, and reduces a part of the industrial data from the storage in a case in which a predetermined condition is satisfied.

### CROSS-REFERENCE TO RELATED APPLICATIONS

This application claims priority under 35 USC 119 from Japanese Patent Application No. 2021-124747 filed on Jul. 29, 2021, the disclosure of which is incorporated by reference herein.

### BACKGROUND

### 1. Technical Field

The technology of the present disclosure relates to a data processing device, a data processing method, and a program.

### 2. Related Art

JP2020-530159A discloses a system that collects data in an industrial environment. The system disclosed in JP2020-530159A can include a data collector communicably connected to a plurality of input channels and network infrastructure, and the data collector collects the data based on a selected data collection routine. The system disclosed in JP2020-530159A can further include a data storage configured to save a plurality of collector paths and the collected data, a data acquisition circuit configured to interpret a plurality of detection values from the collected data, and a data analysis circuit configured to analyze the collected data and determine a total rate of the data collected from the plurality of input channels. The data analysis circuit changes the data collection to reduce an amount of the collected data in a case in which the total rate exceeds a throughput parameter of the network infrastructure.

JP2019-021284A discloses a distributed duplicate data deletion storage system for an IoT device to back up in a data center, and a method of realizing the distributed data deletion thereof. The system disclosed in JP2019-021284A comprises a plurality of storage units, in which each storage unit comprises a control unit that controls a plurality of stored positions and an operation of a storage unit, and a distributed duplicate data deletion module that provides a deterministic function to the control unit and an engine component, and executes each step of the method disclosed in JP2019-021284A in the control unit and/or the engine component.

JP2013-545520A discloses a non-invasive image processing system comprising an image scanner that can generate an image representing a target tissue region of a living body under observation, in which the tissue region of the living body has at least one substructure and the image includes a plurality of image voxels, a signal processing system connected to the image scanner to receive a signal of the image from the image scanner, and a data storage device which communicates with the signal processing system, in which the data storage device is configured to accumulate an atlas including spatial information of the at least one substructure in the tissue region of the living body, and a database including a plurality of pre-accumulated medical images representing the tissue region of the living body, and the signal processing system identifies, based on the atlas and for each of the at least one substructure, a corresponding portion of image voxels in the image; provides a calculated quantification numeral value of the corresponding portion of image voxels for each of the at least one substructure of the tissue region of the living body by performing spatial filtering on the image, and search the database to provide at least one selected medical image from the plurality of pre-accumulated medical images, the at least one selected medical image having a corresponding quantification numeral value that is substantially similar to the calculated quantification numeral value.

### SUMMARY

One embodiment according to the technology of the present disclosure provides a data processing device, a data processing method, and a program that can contribute to securing a free space in a storage as compared with a case in which all industrial data remains in the storage.

A first aspect of the technology of the present disclosure relates to a data processing device comprising a processor, and a storage connected to the processor, in which the processor acquires industrial data, stores the acquired industrial data in the storage, causes a magnetic tape management system that manages a magnetic tape to save the industrial data stored in the storage on the magnetic tape, and reduces a part of the industrial data from the storage in a case in which a predetermined condition is satisfied.

A second aspect of the technology of the present disclosure relates to the data processing device according to the first aspect, in which the processor reduces the part of the industrial data from the storage by deleting the part of the industrial data from the storage, and performs analysis processing of analyzing remaining data that remains in the storage by reducing the part of the industrial data from the storage.

A third aspect of the technology of the present disclosure relates to the data processing device according to the second aspect, in which the remaining data is time-series data obtained from a manufacturing process in time series, and the analysis processing includes derivation processing of deriving behavior data indicating behavior in time series of the manufacturing process from the remaining data.

A fourth aspect of the technology of the present disclosure relates to the data processing device according to the third aspect, in which the processor performs pseudo-reproduction processing of reproducing the behavior in a pseudo manner by using the behavior data derived by the derivation processing.

A fifth aspect of the technology of the present disclosure relates to the data processing device according to the fourth aspect, in which the pseudo-reproduction processing includes processing of comparing the behavior in the same time slot or different time slots to reproduce the behavior in a pseudo manner.

A sixth aspect according to the technology of the present disclosure relates to the data processing device according to any one of the third to fifth aspects, in which the processor controls the manufacturing process based on an analysis result obtained by performing the analysis processing.

A seventh aspect according to the technology of the present disclosure relates to the data processing device according to any one of the first to the sixth aspects, in which the predetermined condition includes a condition that save of the industrial data on the magnetic tape is completed.

An eighth aspect of the technology of the present disclosure relates to a data processing method comprising acquiring industrial data, storing the acquired industrial data in a storage, causing a magnetic tape management system that manages a magnetic tape to save the industrial data stored in the storage on the magnetic tape, and reducing a part of the industrial data from the storage in a case in which a predetermined condition is satisfied.

A ninth aspect of the technology of the present disclosure relates to a program causing a computer to execute a process comprising acquiring industrial data, storing the acquired industrial data in a storage, causing a magnetic tape management system that manages a magnetic tape to save the industrial data stored in the storage on the magnetic tape, and reducing a part of the industrial data from the storage in a case in which a predetermined condition is satisfied.

### BRIEF DESCRIPTION OF THE DRAWINGS

Exemplary embodiments of the present invention will be described in detail based on the following figures, wherein:

FIG. 1 is a block diagram showing an example of a configuration of a data processing system;

FIG. 2 is a block diagram showing an example of a configuration of an electrical system of a factory management device;

FIG. 3 is a block diagram showing an example of a configuration of an electrical system of an analysis apparatus;

FIG. 4 is a conceptual diagram showing an example of a configuration of a magnetic tape management system;

FIG. 5 is a schematic perspective view of an appearance of a magnetic tape cartridge;

FIG. 6 is a conceptual diagram showing an example of a configuration of a magnetic tape drive;

FIG. 7 is a block diagram showing an example of a function of a processor of the analysis apparatus;

FIG. 8 is a conceptual diagram showing an example of an aspect in which the analysis apparatus acquires factory data and stores the acquired factory data in a storage;

FIG. 9 is a conceptual diagram showing an example of an aspect in which the analysis apparatus causes the magnetic tape management system to save the factory data stored in the storage on a magnetic tape;

FIG. 10 is a conceptual diagram showing an example of an aspect in which partial data is deleted from the storage;

FIG. 11 is a conceptual diagram showing an example of an aspect in which the analysis apparatus acquires comparison target data from the magnetic tape management system and stores the acquired comparison target data in the storage;

FIG. 12 is a conceptual diagram showing an example of a processing content of an analysis execution unit;

FIG. 13 is a conceptual diagram showing an example of an aspect in which a pseudo-reproduction result is visualized by making the pseudo-reproduction result into a graph;

FIG. 14 is a conceptual diagram showing an example of an aspect in which the pseudo-reproduction result is visualized by making the pseudo-reproduction result into a motion picture;

FIG. 15 is a flowchart showing an example of a flow of data processing;

FIG. 16 is a flowchart showing an example of a flow of analysis processing included in the data processing;

FIG. 17 is a conceptual diagram showing an example of an aspect in which a controller of the analysis apparatus sets a manufacturing process control value in an electronic apparatus in the manufacturing process; and

FIG. 18 is a conceptual diagram showing an example of an aspect in which a data processing program stored in a storage medium is installed in a computer of the analysis apparatus.

### DETAILED DESCRIPTION

In the following, an example of an embodiment of a data processing device, a data processing method, and a program according to the technology of the present disclosure will be described with reference to the accompanying drawings.

First, the terms used in the following description will be described.

CPU refers to an abbreviation of “central processing unit”. GPU refers to an abbreviation of “graphics processing unit”. RAM refers to an abbreviation of “random access memory”. DRAM refers to an abbreviation of “dynamic random access memory”. SRAM refers to an abbreviation of “static random access memory”. HDD refers to an abbreviation of “hard disk drive”. SSD refers to an abbreviation of “solid state drive”. ASIC refers to an abbreviation of “application specific integrated circuit”. PLD refers to an abbreviation of “programmable logic device”. FPGA refers to an abbreviation of “field-programmable gate array”. SoC refers to an abbreviation of “system-on-a-chip”. IC refers to an abbreviation of “integrated circuit”. RFID refers to an abbreviation of “radio frequency identifier”. EL refers to an abbreviation of “electro-luminescence”. WAN refers to an abbreviation of “wide area network”. LAN refers to an abbreviation of “local area network”. USB refers to an abbreviation of “universal serial bus”. I/F refers to an abbreviation of “interface”.

In the description of the present specification, “parallel” refers to the parallelism in the sense of including an error generally allowed in the technical field to which the technology of the present disclosure belongs, that is the error to the extent that it does not contradict the purpose of the technology of the present disclosure, in addition to the exact parallelism. In addition, in the description of the present specification, “vertical” refers to the verticality in the sense of including an error generally allowed in the technical field to which the technology of the present disclosure belongs, that is the error to the extent that it does not contradict the purpose of the technology of the present disclosure, in addition to the exact verticality. In addition, in the description of the present specification, “perpendicular” refers to the perpendicularity in the sense of including an error generally allowed in the technical field to which the technology of the present disclosure belongs, that is the error to the extent that it does not contradict the purpose of the technology of the present disclosure, in addition to the exact perpendicularity.

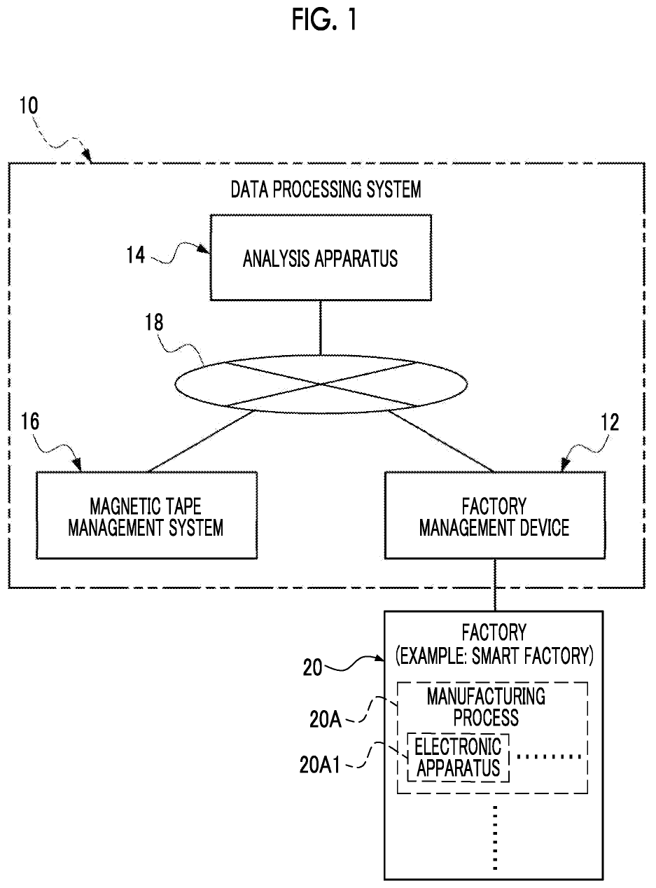

As an example, as shown in FIG. 1, a data processing system 10 comprises a factory management device 12, an analysis apparatus 14, and a magnetic tape management system 16. The analysis apparatus 14 is an example of a “data processing device” according to the technology of the present disclosure. The magnetic tape management system 16 is an example of a “magnetic tape management system” according to the technology of the present disclosure.

The factory management device 12, the analysis apparatus 14, and the magnetic tape management system 16 are connected via a network 18. The network 18 is, for example, the Internet. Here, the Internet is described as an example, but this is merely an example, and the network 18 may be a WAN and/or a LAN (for example, an intranet) or the like. In addition, the factory management device 12 and the analysis apparatus 14 may be integrally formed. In addition, the analysis apparatus 14 may have a function of the factory management device 12, or conversely, the factory management device 12 may have a function of the analysis apparatus 14.

The factory management device 12 is a device that manages a factory 20. Examples of the factory 20 include a smart factory. For example, the factory 20 includes a plurality of manufacturing processes 20A. It should be noted that, in the present embodiment, the concept of the manufacturing process 20A includes concepts of various processes performed on a so-called production line (for example, processing of collecting a material of a product, processing of assembling the product, processing of transporting the product, processing of examining the product, processing of packaging the product, processing of storing the product, and processing of shipping the product).

In the manufacturing process 20A, a plurality of electronic apparatuses 20A1 are used. The plurality of electronic apparatuses 20A1 are electrically connected to the factory management device 12, and are managed by the factory management device 12. Examples of the plurality of electronic apparatuses 20A1 include various sensors (for example, a temperature sensor, a magnetic sensor, a photo sensor, a gyro sensor, an acceleration sensor, a distance-measuring sensor, and an image sensor), a motor, a solenoid, a microphone, a speaker, a display, a computing device (for example, a microcomputer, a personal computer, a server, ASIC, PLD, FPGA, and SoC), a noncontact communication device (for example, RFID, and noncontact reader/writer), a tablet terminal, a smart device, a timer, a stirring device, an illumination device, a cooling device, a heating device, a heat insulation device, a compressor, a vehicle, an air conditioning device, a blower, a suction machine, and a transport device.

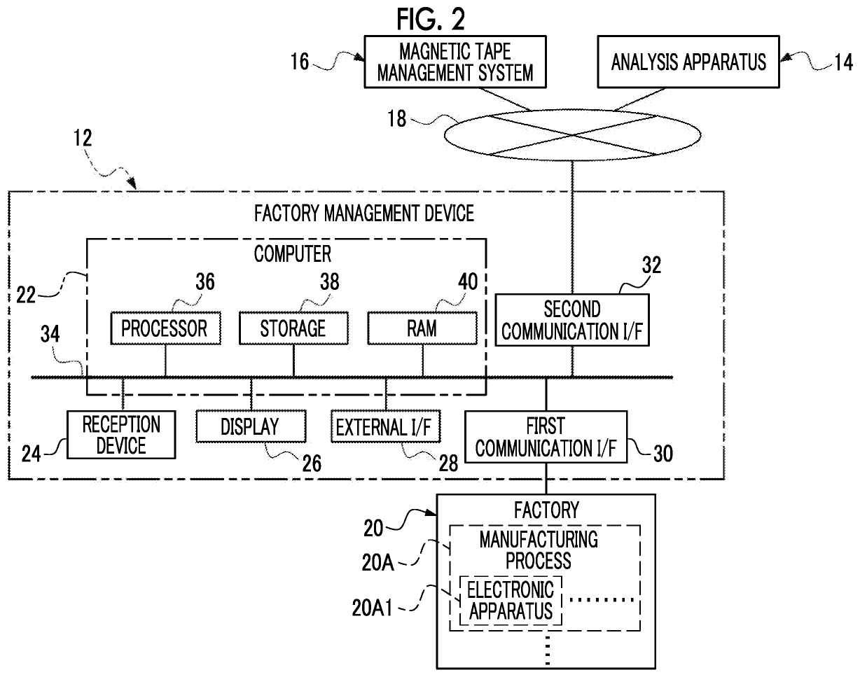

As an example, as shown in FIG. 2, the factory management device 12 comprises a computer 22, a reception device 24, a display 26, an external I/F 28, a first communication I/F 30, a second communication I/F 32, and a bus 34.

The computer 22 comprises a processor 36, a storage 38, and a RAM 40. The processor 36, the storage 38, the RAM 40, the reception device 24, the display 26, the external I/F 28, the first communication I/F 30, and the second communication I/F 32 are connected to the bus 34.

The processor 36 is, for example, a CPU and controls the entire factory management device 12. Here, the CPU is described as an example of the processor 36, but this is merely an example, and the processor 36 may include the CPU and the GPU. The GPU is operated under the control of the CPU and is responsible for executing processing relating to an image. In addition, the processor 36 may be one or more CPUs with integrated GPU functions, or may be one or more CPUs without integrated GPU functions.

A memory is connected to the processor 36. The memory includes the storage 38 and the RAM 40. The storage 38 is a non-volatile storage device that stores various programs, various parameters, and the like. Examples of the storage 38 include a flash memory and an HDD. It should be noted that the flash memory and the HDD are merely examples, and for example, at least one of the flash memory, the HDD, a magnetoresistive memory, or a ferroelectric memory may be used as the storage 38.

The RAM 40 is a memory in which information is transitorily stored, and is used as a work memory by the processor 36. Examples of the RAM 40 include a DRAM and an SRAM.

The reception device 24 receives a command from a user or the like of the factory management device 12. The command received by the reception device 24 is acquired by the processor 36. Examples of the reception device 24 include a keyboard and/or a mouse. The keyboard and/or the mouse is merely an example, and a touch panel and/or a tablet or the like may be used as the reception device 24 instead of the keyboard and/or the mouse or together with the keyboard and/or the mouse. In addition, as the reception device 24, for example, at least one of a touch panel that receives proximity input, a tablet that receives proximity input, an audio input device that receives audio input, or a sensor that receives gesture input may be applied. In addition, the connection between the computer 22 and the reception device 24 may be wired or wireless.

The display 26 displays various pieces of information (for example, an image and a text) under the control of the processor 36. Examples of the display 26 include an EL display and a liquid crystal display.

The external I/F 28 controls the exchange of various pieces of information with a first external device (not shown) present outside the factory management device 12. The first external device may be, for example, at least one of a smart device, a personal computer, a server, a USB memory, a memory card, or a printer. Examples of the external I/F 28 include a USB interface. The first external device is directly or indirectly connected to the USB interface.

The first communication I/F 30 is connected to the factory 20. For example, the first communication I/F 30 is connected to the plurality of electronic apparatuses 20A1 via the network (not shown), such as WAN and/or LAN. The first communication I/F 30 transmits the information in response to a request from the processor 36 to at least one electronic apparatus 20A1 selected by the processor 36 from among the plurality of electronic apparatuses 20A1. In addition, the first communication I/F 30 receives the information transmitted from at least one electronic apparatus 20A1 and outputs the received information to the processor 36 via the bus 34.

The second communication I/F 32 is connected to the network 18. A plurality of first external communication devices (not shown) including the analysis apparatus 14, the magnetic tape management system 16, the personal computer, the smart device, and the like are connected to the network 18, and the second communication I/F 32 controls the exchange of information with the first external communication device via the network 18. For example, the second communication I/F 32 transmits the information in response to a request from the processor 36 to at least one first external communication device selected by the processor 36 from among the plurality of first external communication devices. In addition, the second communication I/F 32 receives the information transmitted from at least one first external communication device, and outputs the received information to the processor 36 via the bus 34.

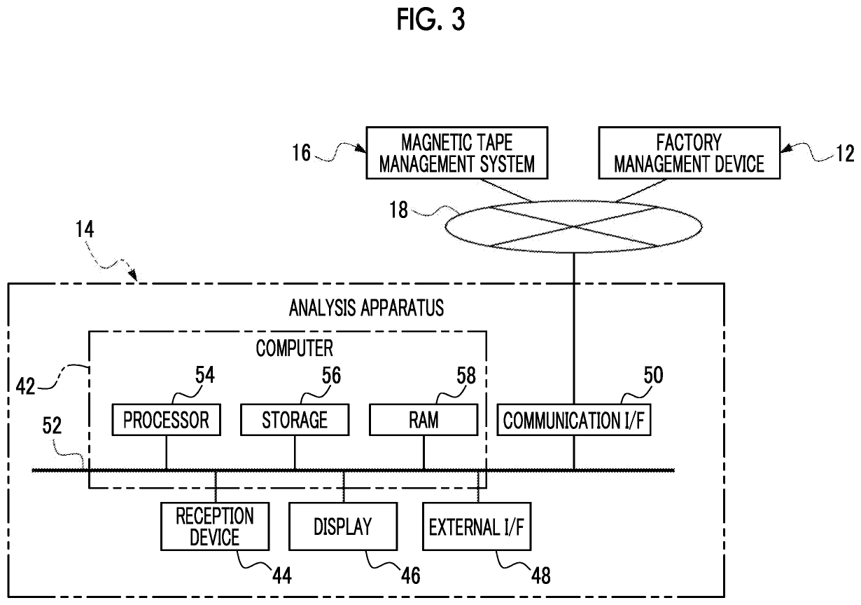

As an example, as shown in FIG. 3, the analysis apparatus 14 comprises a computer 42, a reception device 44, a display 46, an external I/F 48, a communication I/F 50, and a bus 52.

The computer 42 comprises a processor 54, a storage 56, and a RAM 58. The processor 54, the storage 56, the RAM 58, the reception device 44, the display 46, the external I/F 48, and the communication I/F 50 are connected to the bus 52.

The processor 54 is, for example, the CPU and controls the entire analysis apparatus 14. Here, the CPU is described as an example of the processor 54, but this is merely an example, and the processor 54 may include the CPU and the GPU. The GPU is operated under the control of the CPU and is responsible for executing processing relating to an image. In addition, the processor 54 may be one or more CPUs with integrated GPU functions, or may be one or more CPUs without integrated GPU functions.

A memory is connected to the processor 54. The memory includes the storage 56 and the RAM 58. The storage 56 is a non-volatile storage device that stores various programs, various parameters, and the like. The storage 56 is an example of a “storage” according to the technology of the present disclosure. Examples of the storage 56 include the flash memory and the HDD. It should be noted that the flash memory and the HDD are merely examples, and for example, at least one of the flash memory, the HDD, the magnetoresistive memory, or the ferroelectric memory may be used as the storage 56.

The RAM 58 is a memory in which information is transitorily stored, and is used as a work memory by the processor 54. Examples of the RAM 58 include the DRAM and an SRAM.

The reception device 44 receives a command from the user or the like of the analysis apparatus 14. The command received by the reception device 44 is acquired by the processor 54. Examples of the reception device 44 include the keyboard and/or the mouse. The keyboard and/or the mouse is merely an example, and a touch panel and/or a tablet or the like may be used as the reception device 44 instead of the keyboard and/or the mouse or together with the keyboard and/or the mouse. In addition, as the reception device 44, for example, at least one of a touch panel that receives proximity input, a tablet that receives proximity input, an audio input device that receives audio input, or a sensor that receives gesture input may be applied. In addition, the connection between the computer 42 and the reception device 44 may be wired or wireless.

The display 46 displays various pieces of information (for example, an image and a text) under the control of the processor 54. Examples of the display 46 include the EL display and the liquid crystal display.

The external I/F 48 controls the exchange of various pieces of information with a second external device (not shown) present outside the analysis apparatus 14. The second external device may be, for example, at least one of the smart device, the personal computer, the server, the USB memory, the memory card, or the printer. Examples of the external I/F 48 include the USB interface. The second external device is directly or indirectly connected to the USB interface.

The communication I/F 50 is connected to the network 18. A plurality of second external communication devices (not shown) including the factory management device 12, the magnetic tape management system 16, the personal computer, the smart device, and the like are connected to the network 18, and the communication I/F 50 controls the exchange of information with the second external communication device via the network 18. For example, the communication I/F 50 transmits the information in response to a request from the processor 54 to at least one second external communication device selected by the processor 54 from among the plurality of second external communication devices. In addition, the communication I/F 50 receives the information transmitted from at least one second external communication device, and outputs the received information to the processor 54 via the bus 52.

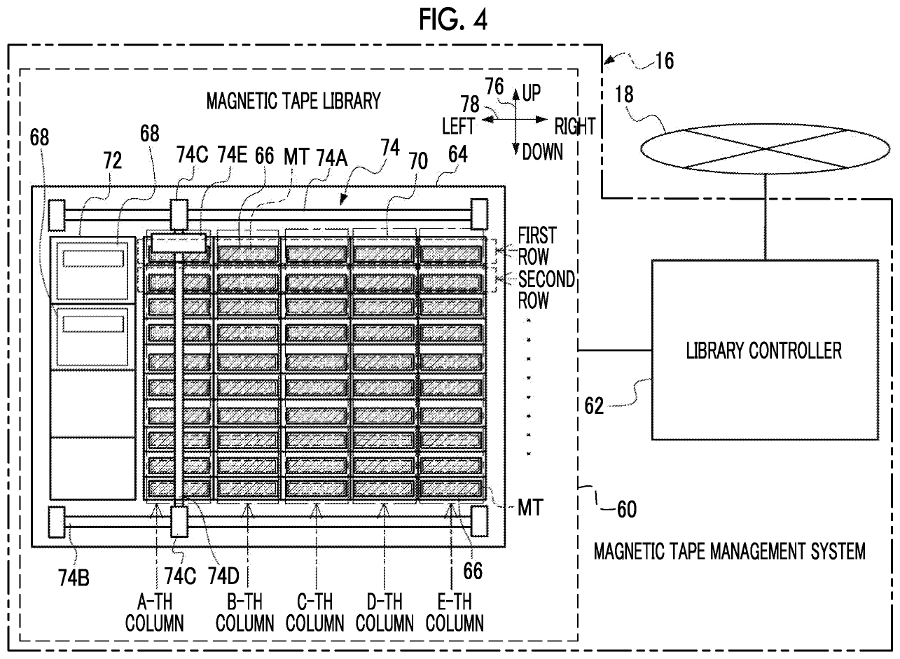

As an example, as shown in FIG. 4, the magnetic tape management system 16 is a system that manages a magnetic tape MT storing data, and comprises a magnetic tape library 60 and a library controller 62. The library controller 62 comprises a processor (not shown), a storage (not shown), a RAM (not shown), a communication I/F (not shown), and the like. The library controller 62 is connected to the network 18. The library controller 62 is also connected to the magnetic tape library 60. The library controller 62 controls the magnetic tape library 60 in accordance with a command received from the outside (for example, the analysis apparatus 14 (see FIG. 3)) via the network 18.

The magnetic tape library 60 comprises a storage shelf 64. A plurality of magnetic tape cartridges 66 and one or more magnetic tape drives 68 are stored in the storage shelf 64. Each magnetic tape cartridge 66 accommodates the magnetic tape MT. In the storage shelf 64, a plurality of cartridge storage cells 70, a plurality of drive storage cells 72, and a transport mechanism 74 are provided.

One magnetic tape cartridge 66 is stored in each cartridge storage cell 70. For example, in a case in which “M” and “N” are natural numbers of 2 or more, the plurality of cartridge storage cells 70 are arranged in a lattice pattern of M rows×N columns (10 rows×5 columns in the example shown in FIG. 4). It should be noted that, here, although the lattice pattern arrangement is described as an example, this is merely an example, and other arrangement methods may be used.

FIG. 4 shows double-headed arrows 76 and 78. The double-headed arrow 76 indicates a vertically upper direction (hereinafter referred to as “upper direction”) and a vertically lower direction (hereinafter referred to as “lower direction”) in a front view with respect to the magnetic tape library 60. On the paper surface of FIG. 4, the upper direction refers to an upper direction toward the paper surface, and the lower direction refers to a lower direction toward the paper surface. The double-headed arrow 78 indicates a horizontally left direction (hereinafter referred to as “left direction”) and a horizontally right direction (hereinafter referred to as “right direction”) in a front view with respect to the magnetic tape library 60. On the paper surface of FIG. 4, the left direction refers to a left direction toward the paper surface, and the right direction refers to a right direction toward the paper surface.

Rows of the cartridge storage cells 70 are designated with row numbers 1 to 10 in order from the top in FIG. 4, and columns of the cartridge storage cells 70 are designated with column symbols A to E in order from the left in FIG. 4. Each cartridge storage cell 70 is designated with a cell name (for example, a name determined by using the row number and the column symbol) for identifying the position of the cartridge storage cell 70. For example, the cartridge storage cell 70 positioned in the first row of the A column designated with the cell name “A1”. The library controller 62 specifies the cartridge storage cell 70 in accordance with the cell name given from the outside.

The magnetic tape cartridge 66 is loaded into the magnetic tape drive 68. The library controller 62 outputs a tape drive driving signal to the magnetic tape drive 68. The tape drive driving signal is a signal for giving a command for driving to the magnetic tape drive 68. The magnetic tape drive 68 pulls out the magnetic tape MT from the magnetic tape cartridge 66 in response to the tape drive driving signal, and selectively reads the data from the magnetic tape MT and writes the data on the magnetic tape MT.

The transport mechanism 74 comprises an upper bar 74A, a lower bar 74B, a pair of horizontally movable robots 74C, a vertical bar 74D, and a vertically movable robot 74E. The upper bar 74A is fixed to an upper part of the storage shelf 64 to extend in the horizontal direction (in the example shown in FIG. 4, in the direction of the double-headed arrow 78). The lower bar 74B is fixed to a lower part of the storage shelf 64 in parallel with the upper bar 74A.

The pair of horizontally movable robots 74C are attached to both end portions of the vertical bar 74D. In addition, the pair of horizontally movable robots 74C are fitted in the upper bar 74A and the lower bar 74B. The horizontally movable robots 74C are self-propelled robots that can move along the horizontal direction, and move the vertical bar 74D in the horizontal direction along the upper bar 74A and the lower bar 74B while maintaining the direction of the vertical bar 74D to be perpendicular to the directions of the upper bar 74A and the lower bar 74B. The vertically movable robot 74E is attached to the vertical bar 74D. The vertically movable robot 74E is a self-propelled robot that can move along the vertical direction (in the example shown in FIG. 4, the direction of the double-headed arrow 76). That is, the vertically movable robot 74E moves in the vertical direction along the vertical bar 74D. The vertically movable robot 74E is provided with a holder (not shown) that holds the magnetic tape cartridge 66.

The library controller 62 outputs a transport mechanism driving signal to the transport mechanism 74. The transport mechanism driving signal is a signal for giving a command for driving to the transport mechanism 74. A motor (not shown) is mounted on each of the horizontally movable robots 74C and the vertically movable robot 74E, and each motor of the horizontally movable robots 74C and the vertically movable robot 74E is driven in response to the transport mechanism driving signal input from the library controller 62 to generate the power. In the example shown in FIG. 4, the position at which a part of the vertically movable robot 74E faces the cartridge storage cell 70 of the cell number “A1” is set as a reference position, and the horizontally movable robots 74C and the vertically movable robot 74E are self-propelled by using the power generated by the motor in response to the transport mechanism driving signal input from the library controller 62.

The library controller 62 comprehensively controls the magnetic tape drive 68 and the transport mechanism 74 in accordance with the command received from the outside (for example, the analysis apparatus 14 (see FIG. 3)) via the network 18. As a result, the magnetic tape cartridge 66 is extracted from the cartridge storage cell 70, the magnetic tape cartridge 66 is stored in the cartridge storage cell 70, the magnetic tape cartridge 66 is transported, the magnetic tape cartridge 66 is loaded into the magnetic tape drive 68, the magnetic tape cartridge 66 is extracted from the magnetic tape drive 68, the data is read from the magnetic tape MT accommodated in the magnetic tape cartridge 66, the data is written on the magnetic tape MT accommodated in the magnetic tape cartridge 66, and the like.

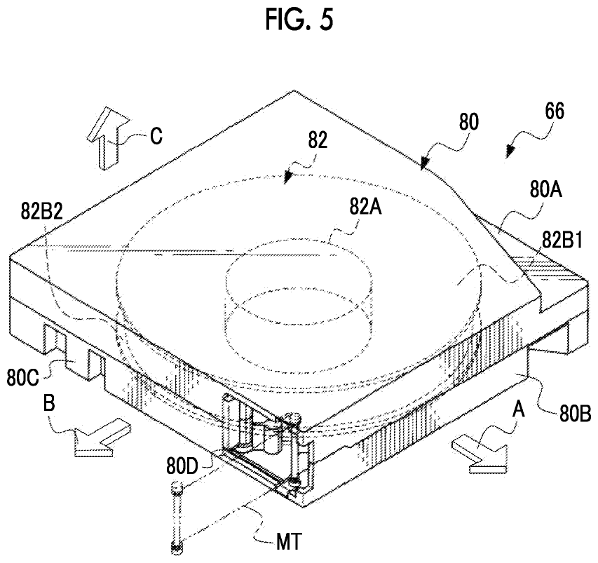

As an example, as shown in FIG. 5, the magnetic tape cartridge 66 has a substantially rectangular shape in a plan view, and comprises a box-shaped case 80.

In the following description, for convenience of description, in FIG. 5, a loading direction of the magnetic tape cartridge 66 into the magnetic tape drive 68 (see FIG. 4) is indicated by an arrow A, a direction of the arrow A is defined as a front direction of the magnetic tape cartridge 66, and a side of the magnetic tape cartridge 66 in the front direction is defined as a front side of the magnetic tape cartridge 66. In addition, a direction opposite to the front direction of the magnetic tape cartridge 66 is defined as a rear direction of the magnetic tape cartridge 66, and a side of the magnetic tape cartridge 66 in the rear direction is defined as a rear side of the magnetic tape cartridge 66.

In addition, in the following description, for convenience of description, in FIG. 5, a direction of an arrow B orthogonal to the direction of the arrow A is defined as a right direction, and a side of the magnetic tape cartridge 66 in the right direction is defined as a right side of the magnetic tape cartridge 66. In addition, a direction opposite to the right direction of the magnetic tape cartridge 66 is defined as a left direction of the magnetic tape cartridge 66, and a side of the magnetic tape cartridge 66 in the left direction is defined as a left side of the magnetic tape cartridge 66.

In addition, in the following description, for convenience of description, in FIG. 5, a direction orthogonal to the direction of the arrow A and the direction of the arrow B is indicated by an arrow C, a direction of the arrow C is defined as an upper direction of the magnetic tape cartridge 66, and a side of the magnetic tape cartridge 66 in the upper direction is defined as an upper side of the magnetic tape cartridge 66. In addition, a direction opposite to the upper direction of the magnetic tape cartridge 66 is defined as a lower direction of the magnetic tape cartridge 66, and a side of the magnetic tape cartridge 66 in the lower direction is defined as a lower side of the magnetic tape cartridge 66.

The case 80 is formed of resin, such as polycarbonate, and comprises an upper case 80A and a lower case 80B. The upper case 80A and the lower case 80B are bonded by welding (for example, ultrasound welding) and screwing in a state in which a lower peripheral edge surface of the upper case 80A and an upper peripheral edge surface of the lower case 80B are brought into contact with each other. The bonding method is not limited to welding and screwing, and other bonding methods may be used.

Inside the case 80, a cartridge reel 82 is rotatably accommodated. The cartridge reel 82 comprises a reel hub 82A, an upper flange 82B1, and a lower flange 82B2. The reel hub 82A is formed in a cylindrical shape. The reel hub 82A is a shaft center portion of the cartridge reel 82, has a shaft center direction along an up-down direction of the case 80, and is disposed in a center portion of the case 80. Each of the upper flange 82B1 and the lower flange 82B2 is formed in an annular shape. A center portion of the upper flange 82B1 in a plan view is fixed to an upper end portion of the reel hub 82A, and a center portion of the lower flange 82B2 in a plan view is fixed to a lower end portion of the reel hub 82A. The magnetic tape MT is wound around an outer peripheral surface of the reel hub 82A, and an end portion of the magnetic tape MT in a width direction is held by the upper flange 82B1 and the lower flange 82B2.

An opening 80D is formed on a front side of a right wall 80C of the case 80. The magnetic tape MT is pulled out from the opening 80D.

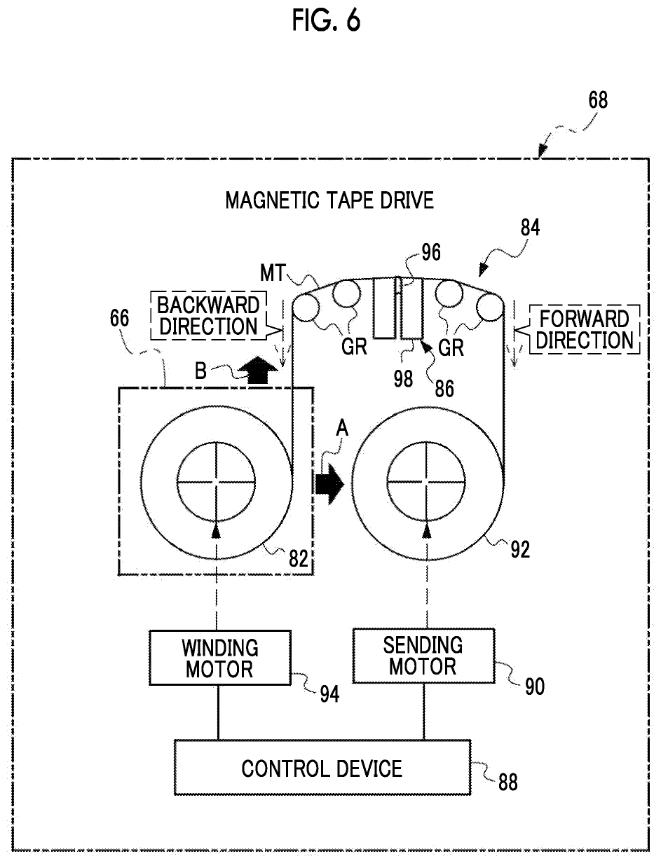

As an example, as shown in FIG. 6, the magnetic tape drive 68 comprises a transport device 84, a read/write head 86, and a control device 88. The magnetic tape cartridge 66 is loaded into the magnetic tape drive 68. The magnetic tape drive 68 is a device that pulls out the magnetic tape MT from the magnetic tape cartridge 66, reads the data from the pulled out magnetic tape MT using the read/write head 86, and writes the data on the magnetic tape MT.

The control device 88 controls the entire magnetic tape drive 68. In the present embodiment, although the control device 88 is realized by the ASIC, the technology of the present disclosure is not limited to this. For example, the control device 88 may be realized by the FPGA. Alternatively, the control device 88 may be realized by the computer including the CPU, the flash memory, and the RAM. In addition, the control device 88 may be realized by combining two or more of the ASIC, the FPGA, and the computer. That is, the control device 88 may be realized by a combination of a hardware configuration and a software configuration.

The transport device 84 is a device that selectively transports the magnetic tape MT in a forward direction and a backward direction, and comprises a sending motor 90, a sending reel 92, a winding motor 94, and a plurality of guide rollers GR.

The sending motor 90 rotationally drives the sending reel 92 under the control of the control device 88. The control device 88 controls the sending motor 90 to control a rotation direction, a rotation speed, a rotation torque, and the like of the sending reel 92.

In a case in which the magnetic tape MT is pulled out by the sending reel 92, the control device 88 rotates the sending motor 90 such that the magnetic tape MT travels in the forward direction. The rotation speed, the rotation torque, and the like of the sending motor 90 are adjusted in accordance with a speed of the magnetic tape MT pulled out by the sending reel 92.

The winding motor 94 rotationally drives the cartridge reel 82 in the magnetic tape cartridge 66 under the control of the control device 88. The control device 88 controls the winding motor 94 to control a rotation direction, a rotation speed, a rotation torque, and the like of the cartridge reel 82.

In a case in which the magnetic tape MT is wound around the cartridge reel 82, the control device 88 rotates the winding motor 94 such that the magnetic tape MT travels in the backward direction. The rotation speed, the rotation torque, and the like of the winding motor 94 are adjusted in accordance with a speed of the magnetic tape MT wound around the cartridge reel 82.

The rotation speed, the rotation torque, and the like of each of the sending motor 90 and the winding motor 94 are adjusted as described above, so that tension in a predetermined range is applied to the magnetic tape MT. Here, the predetermined range refers to, for example, a range of the tension obtained by computer simulation and/or test with an actual machine by the read/write head 86 as a range of the tension in which the data can be read from the magnetic tape MT and the data can be written on the magnetic tape MT.

In the present embodiment, the tension of the magnetic tape MT is controlled by controlling the rotation speed, the rotation torque, and the like of the sending motor 90 and the winding motor 94, but the technology of the present disclosure is not limited to this. For example, the tension of the magnetic tape MT may be controlled by using a dancer roller, or may be controlled by drawing the magnetic tape MT into a vacuum chamber.

Each of the plurality of guide rollers GR is a roller which guides the magnetic tape MT. A traveling path of the magnetic tape MT is determined by separately disposing the plurality of guide rollers GR at positions straddling the read/write head 86 between the magnetic tape cartridge 66 and the sending reel 92.

The read/write head 86 comprises a read/write element 96 and a holder 98. The read/write element 96 is held by the holder 98 to come into contact with the traveling magnetic tape MT, reads the data from the magnetic tape MT transported by the transport device 84, and writes the data on the magnetic tape transported MT by the transport device 84.

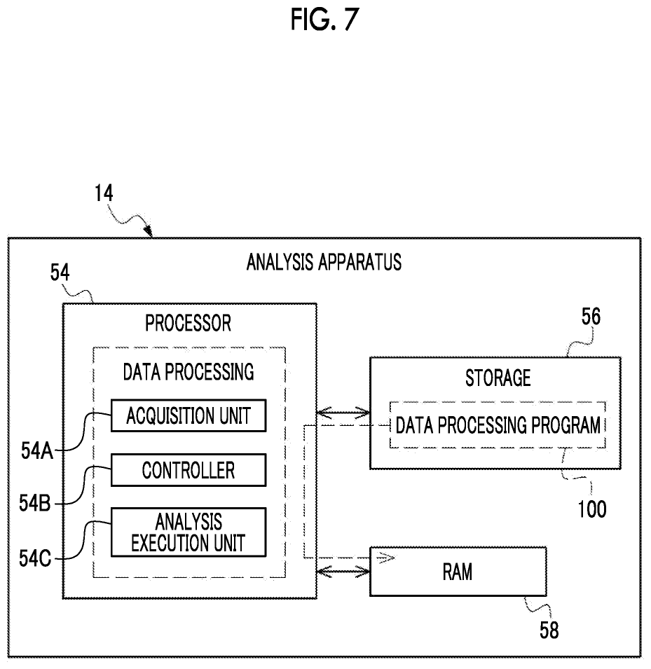

As an example, as shown in FIG. 7, in the analysis apparatus 14, data processing is performed by the processor 54. A data processing program 100 is stored in the storage 56. The processor 54 reads out the data processing program 100 from the storage 56 and executes the read-out data processing program 100 on the RAM 58 to perform the data processing. The data processing is realized by the processor 54 operating as an acquisition unit 54A, a controller 54B, and an analysis execution unit 54C in accordance with the data processing program 100.

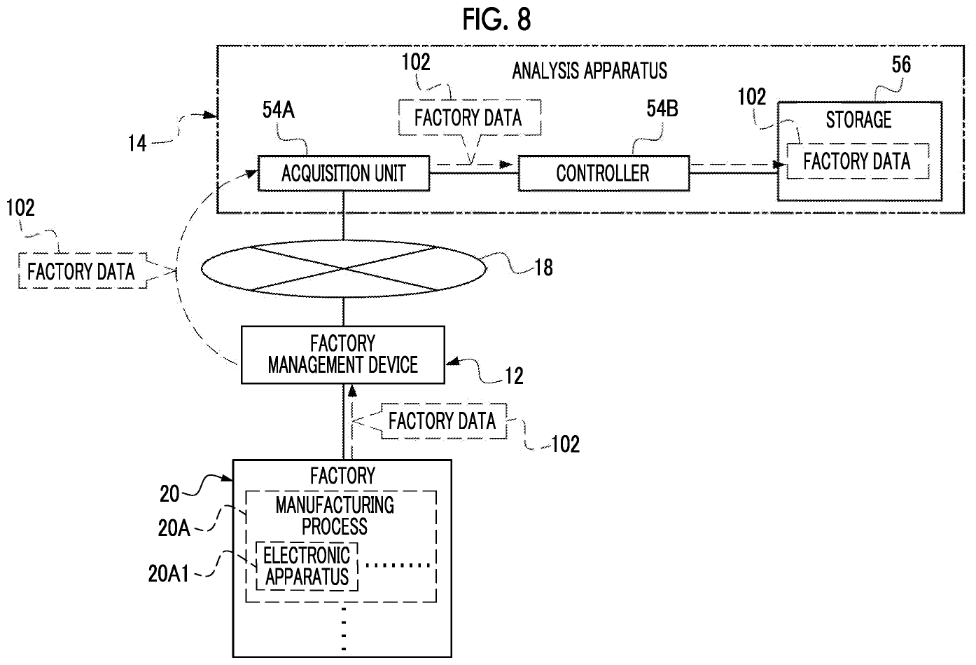

As an example, as shown in FIG. 8, the factory management device 12 collects factory data 102 from the factory 20. The factory data 102 is an example of “industrial data” according to the technology of the present disclosure. The factory data 102 is data obtained in time series from at least one manufacturing process 20A. The data obtained in time series from at least one manufacturing process 20A refers to, for example, data obtained in time series from at least one electronic apparatus 20A1 included in at least one manufacturing process 20A. The factory data 102 is designated with a time point in time series for each unit time.

In the analysis apparatus 14, the acquisition unit 54A acquires the factory data 102 from the factory management device 12 via the network 18. The controller 54B stores the factory data 102 acquired by the acquisition unit 54A in the storage 56.

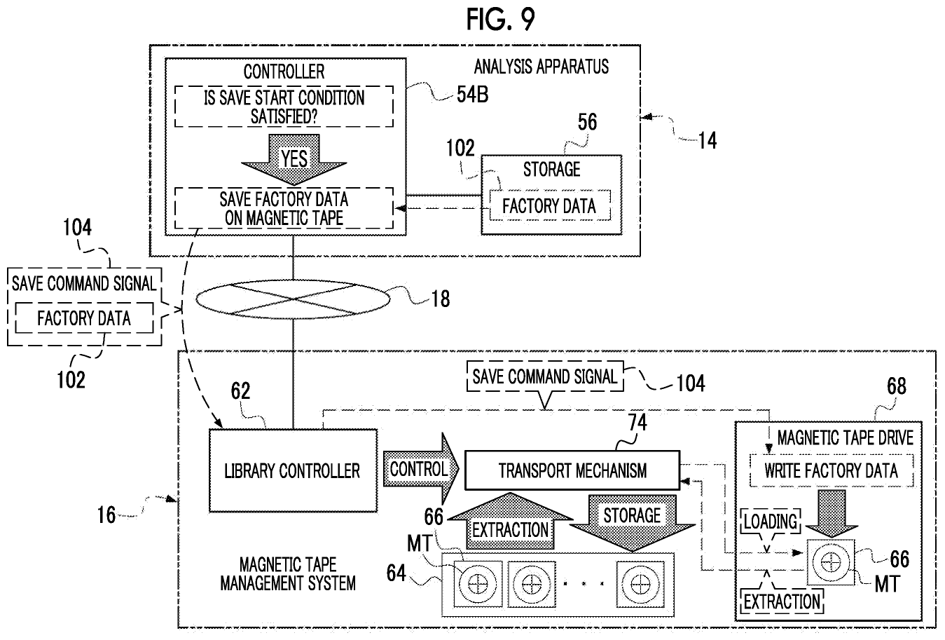

As an example, as shown in FIG. 9, in the analysis apparatus 14, the controller 54B determines whether or not a condition for saving the factory data 102 on the magnetic tape MT (hereinafter referred to as “save start condition”) is satisfied. Examples of the save start condition include a condition that the factory data 102 for a predetermined time is stored in the storage 56, and a condition that the factory data 102 in a predetermined data amount is stored in the storage 56.

Here, in a case in which the save start condition is satisfied, the controller 54B acquires the factory data 102 from the storage 56. Then, the controller 54B generates a save command signal 104, and transmits the generated save command signal 104 to the magnetic tape management system 16 via the network 18, so that the magnetic tape management system 16 is caused to save the factory data 102 on the magnetic tape MT.

The save command signal 104 is a signal for giving a command for saving of the factory data 102 on the magnetic tape MT. The save command signal 104 includes the factory data 102 acquired from the storage 56 by the controller 54B. In addition, the save command signal 104 also includes cartridge specification information (not shown) for specifying the magnetic tape cartridge 66 that accommodates the magnetic tape MT that is a save destination of the factory data 102.

For example, the cartridge specification information is generated by the controller 54B in accordance with the time point included in the factory data 102. The plurality of magnetic tape cartridges 66 stored in the storage shelf 64 of the magnetic tape management system 16 are divided in time series, and the controller 54B generates information (for example, information indicating the “cell name”) for specifying the magnetic tape cartridge 66 temporally corresponding to the time point included in the factory data 102, as the cartridge specification information.

In the magnetic tape management system 16, the library controller 62 receives the save command signal 104. The library controller 62 controls the transport mechanism 74 in response to the received save command signal 104, so that the transport mechanism 74 extracts the magnetic tape cartridge 66 from the storage shelf 64 and loads the extracted magnetic tape cartridge 66 into the magnetic tape drive 68. Here, the magnetic tape cartridge 66 extracted from the storage shelf 64 by the transport mechanism 74 is specified from the cartridge specification information included in the save command signal 104.

It should be noted that, here, although the form example has been described in which the magnetic tape cartridge 66 specified from the cartridge specification information is extracted from the storage shelf 64 by the transport mechanism 74, this is merely an example. For example, from among the plurality of magnetic tape cartridges 66 stored in the storage shelf 64, the magnetic tape cartridge 66 selected in accordance with a predetermined rule (for example, the magnetic tape cartridge 66 to which today's date is assigned, the magnetic tape cartridge 66 in which the factory data 102 is not stored, and the magnetic tape cartridge 66 that is determined in advance) may be extracted from the storage shelf 64 by the transport mechanism 74.

The library controller 62 outputs the save command signal 104 to the magnetic tape drive 68. The magnetic tape drive 68 writes the factory data 102 on the magnetic tape MT in the loaded magnetic tape cartridge 66 in response to the save command signal 104 input from the library controller 62.

The magnetic tape MT on which the factory data 102 is written by the magnetic tape drive 68 is accommodated in the magnetic tape cartridge 66. Then, the magnetic tape cartridge 66 accommodating the magnetic tape MT on which the factory data 102 is written is extracted from the magnetic tape drive 68 by the transport mechanism 74 and stored in the storage shelf 64.

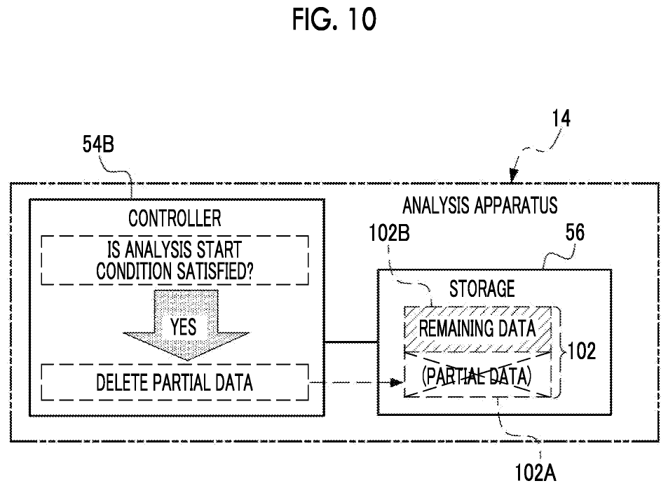

As an example, as shown in FIG. 10, in the analysis apparatus 14, the controller 54B determines whether or not a condition for starting the analysis processing (for example, the processing of analyzing the factory data 102) (hereinafter referred to as “analysis start condition”) is satisfied. Examples of the analysis start condition include a condition that the save of the factory data 102 on the magnetic tape MT is completed. It should be noted that the analysis start condition is an example of a “predetermined condition” according to the technology of the present disclosure.

Here, in a case in which the analysis start condition is satisfied, the controller 54B reduces partial data 102A, which is a part of the factory data 102 stored in the storage 56, from the storage 56. Here, the reduction means, for example, deleting a part of the partial data 102A from the storage 56. The partial data 102A refers to, for example, data unnecessary for the analysis processing. For example, in a case in which the factory data 102 stored in the storage 56 is data for 24 hours and the data required for the analysis processing is data in a period from 15:00 to 16:00, the partial data 102A, which is a target to be deleted from the storage 56, is data in a period other than the period from 15:00 to 16:00.

It should be noted that, here, although partial data 102A is deleted from the storage 56, this is merely an example, and the factory data 102 may be compressed. For example, in a case in which the factory data 102 is image data, a resolution of the image data may be lowered to the extent that it does not affect the analysis processing. In a case in which the factory data 102 is audio data, the audio data of a specific frequency may be cut to the extent that it does not affect the analysis processing. In a case in which the factory data 102 is measurement data, the measurement data may be thinned out to the extent that it does not affect the analysis processing.

Remaining data 102B, which is the time-series data remaining in the storage 56 by reducing the partial data 102A from the storage 56, is a target subjected to the analysis processing.

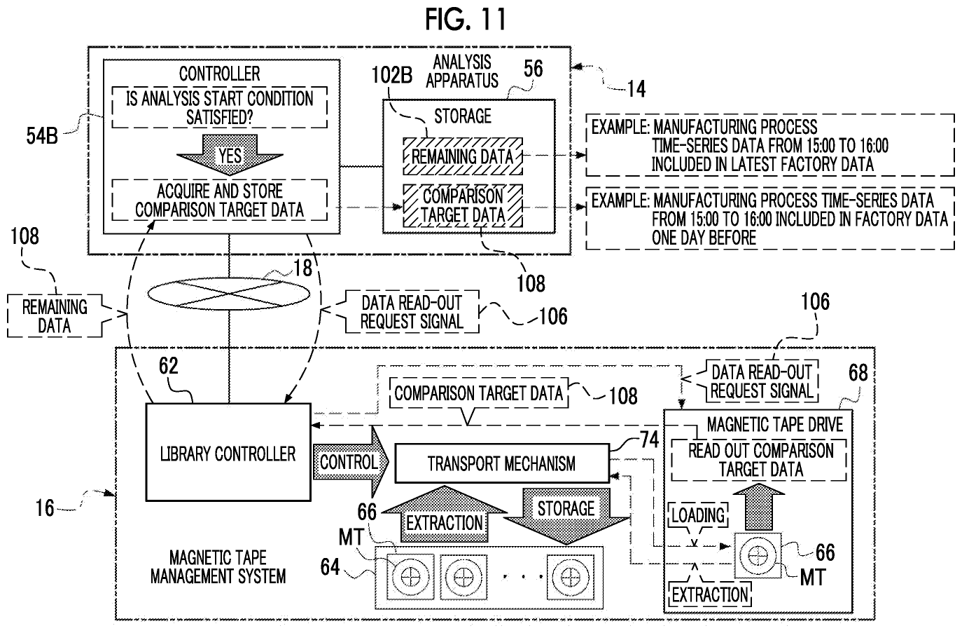

As an example, as shown in FIG. 11, in a case in which the analysis start condition is satisfied, the controller 54B generates a data read-out request signal 106, and transmits the generated data read-out request signal 106 to the magnetic tape management system 16 via the network 18. The data read-out request signal 106 refers to a signal for requesting the magnetic tape management system 16 to read out comparison target data 108 from the magnetic tape MT. Here, the comparison target data 108 refers to data to be compared with the remaining data 102B in the analysis processing in the data stored in a plurality of magnetic tapes MT (for example, the factory data 102 stored in the magnetic tape MT in the past).

In addition, the data read-out request signal 106 also includes a data storage position command signal (not shown). The data storage position command signal is a signal for giving a command for instructing the magnetic tape management system 16 to read out the data stored in which position of the magnetic tape MT in which magnetic tape cartridge 66 as the comparison target data 108. The data storage position command signal is generated by the controller 54B in accordance with a content of the analysis processing. For example, in a case in which the content of the analysis processing is a content that behavior in time series of the manufacturing process 20A in the same time slot with different dates is analyzed, and the remaining data 102B is data from 15:00 to 16:00 of the latest factory data 102 obtained from the factory 20, the data storage position command signal is a signal (for example, a signal for specifying the magnetic tape cartridge 66 and specifying the position in the magnetic tape MT accommodated in the specified magnetic tape cartridge 66) for specifying the position at which the data in the same time slot (that is, the time slot from 15:00 to 16:00) in the past factory data 102 stored in the plurality of magnetic tapes MT is stored.

In the magnetic tape management system 16, the library controller 62 receives the data read-out request signal 106. The library controller 62 controls the transport mechanism 74 in response to the received data read-out request signal 106, so that the transport mechanism 74 extracts the magnetic tape cartridge 66 from the storage shelf 64 and loads the extracted magnetic tape cartridge 66 into the magnetic tape drive 68. Here, the magnetic tape cartridge 66 extracted from the storage shelf 64 by the transport mechanism 74 is specified from the data storage position command signal included in the data read-out request signal 106.

The library controller 62 outputs the data read-out request signal 106 to the magnetic tape drive 68. The magnetic tape drive 68 reads out the data stored at the position specified from the data storage position command signal included in the data read-out request signal 106 input from the library controller 62 in the magnetic tape MT in the loaded magnetic tape cartridge 66, as the comparison target data 108. Then, the library controller 62 transmits the comparison target data 108 read out from the magnetic tape MT by the magnetic tape drive 68 to the analysis apparatus 14 via the network 18.

The magnetic tape MT from which the comparison target data 108 is read out by the magnetic tape drive 68 is accommodated in the magnetic tape cartridge 66. Then, the magnetic tape cartridge 66 accommodating the magnetic tape MT from which the comparison target data 108 is read out is extracted from the magnetic tape drive 68 by the transport mechanism 74 and stored in the storage shelf 64.

In the analysis apparatus 14, the controller 54B acquires the comparison target data 108 by receiving the comparison target data 108 transmitted from the library controller 62. Then, the controller 54B stores the acquired comparison target data 108 in the storage 56.

In the example shown in FIG. 11, as an example of the remaining data 102B stored in the storage 56, manufacturing process time-series data in the time slot from 15:00 to 16:00 included in the latest factory data 102 is shown. The manufacturing process time-series data refers to, for example, time-series data obtained in time series from the specific electronic apparatus 20A1 included in the specific manufacturing process 20A (see FIGS. 1 and 2). In addition, in the example shown in FIG. 11, as an example of the comparison target data 108 stored in the storage 56, the manufacturing process time-series data in the time slot from 15:00 to 16:00 included in the factory data 102 one day before is shown.

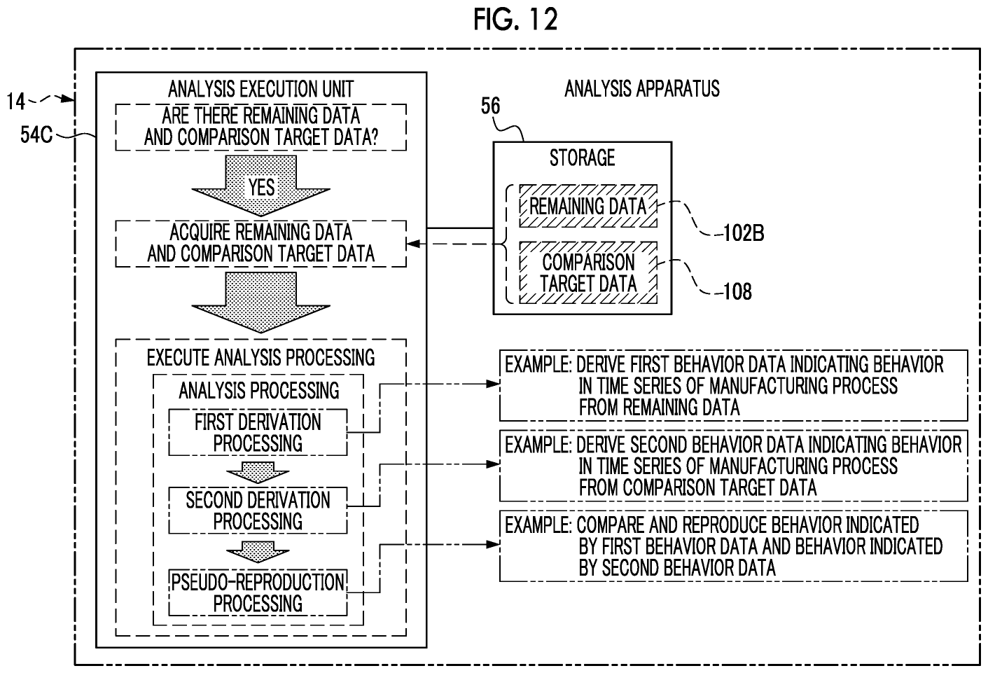

As an example, as shown in FIG. 12, in the analysis apparatus 14, the analysis execution unit 54C determines whether or not the remaining data 102B and the comparison target data 108 are stored in the storage 56. Here, in a case in which the remaining data 102B and the comparison target data 108 are stored in the storage 56, the analysis execution unit 54C acquires the remaining data 102B and the comparison target data 108 from the storage 56. Then, the analysis execution unit 54C executes the analysis processing. The analysis processing is processing of analyzing the remaining data 102B. In the example shown in FIG. 12, the analysis execution unit 54C performs processing of analyzing the remaining data 102B and the comparison target data 108 as the analysis processing.

The analysis processing includes first derivation processing and second derivation processing. The first derivation processing is an example of “derivation processing” according to the technology of the present disclosure. The first derivation processing is processing of deriving first behavior data from the remaining data 102B. The first behavior data refers to, for example, data indicating the behavior of the time series obtained from the today's manufacturing process 20A. Examples of the behavior of the time series obtained from the today's manufacturing process 20A include the behavior of the time series of the specific manufacturing process 20A in the time slot from 15:00 to 16:00 today. The second derivation processing is processing of deriving second behavior data from the comparison target data 108. The second behavior data refers to data indicating the behavior of the time series obtained from the manufacturing process 20A one day before, for example. Examples of the behavior of the time series obtained from the manufacturing process 20A one day before is the behavior of the time series of the specific manufacturing process 20A in the time slot from 15:00 to 16:00 one day before.

In addition, the analysis processing further includes pseudo-reproduction processing. The pseudo-reproduction processing is processing of reproducing the behavior indicated by the first behavior data (here, as an example, the behavior of the time series of the specific manufacturing process 20A in the time slot from the 15:00 to 16:00 today) and the behavior indicated by the second behavior data (here, as an example, the behavior of the time series of the specific manufacturing process 20A in the time slot from the 15:00 to 16:00 one day before), in a pseudo manner. The pseudo-reproduction refers to, for example, simulation and/or emulation. The simulation and/or emulation is realized by making the behavior into a chart (for example, graphing and/or heat mapping), making the behavior into an image, and making the behavior into an audio.

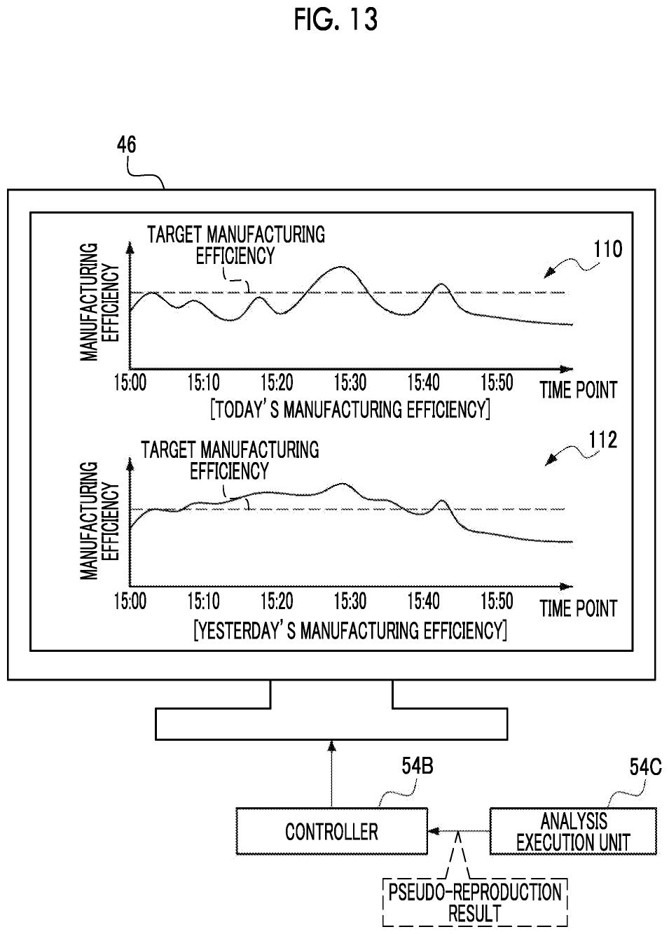

As an example, as shown in FIG. 13, the controller 54B displays a result obtained by performing the pseudo-reproduction processing by the analysis execution unit 54C (hereinafter, referred to as “pseudo-reproduction result”) on the display 46. In the example shown in FIG. 13, the behavior indicated by the first behavior data and the behavior indicated by the second behavior data are made into graphs, and a graph 110 expressing the behavior indicated by the first behavior data and a graph 112 expressing the behavior indicated by the second behavior data are reproduced in a pseudo manner in a comparable state.

The graph 110 shows a temporal change of the manufacturing efficiency of the specific manufacturing process 20A in the time slot from 15:00 to 16:00 today. The graph 112 shows a temporal change of the manufacturing efficiency of the specific manufacturing process 20A in the time slot from 15:00 to 16:00 yesterday (that is, one day before). Each of the graphs 110 and 112 also shows a target manufacturing efficiency (in the example shown in FIG. 13, the target manufacturing efficiency).

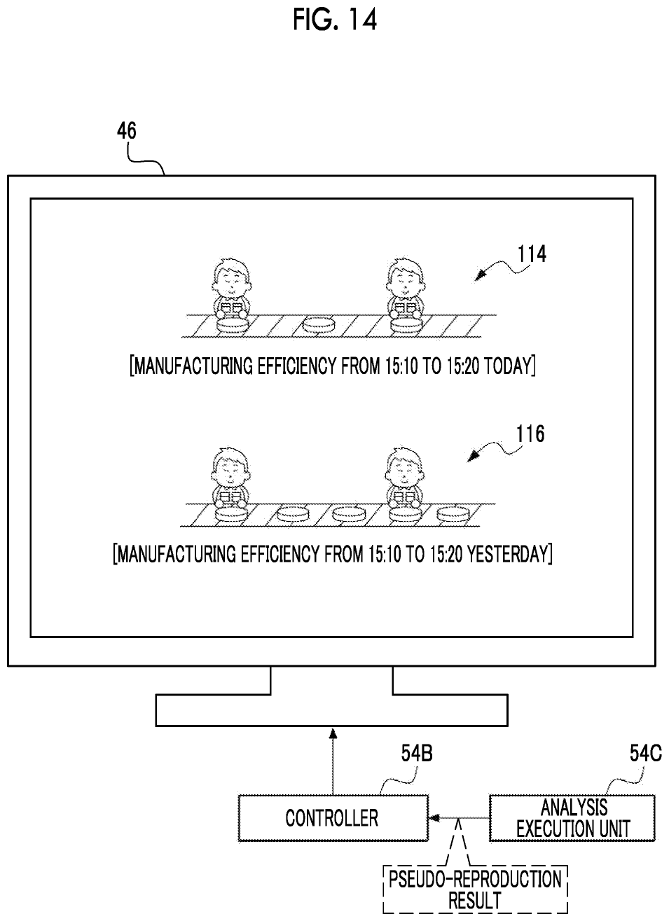

In the example shown in FIG. 13, although the form example has been described in which the difference in the manufacturing efficiency between the present and the past in the same time slot is grasped at a glance by the user and the like by comparing the graph 110 with the graph 112, this is merely an example. For example, as shown in FIG. 14, the behavior indicated by the first behavior data and the behavior indicated by the second behavior data may be made into motion pictures and displayed on the display 46. In this case, for example, the controller 54B displays motion pictures 114 and 116 indicating the pseudo-reproduction results on the display 46. In the example shown in FIG. 14, a motion picture indicating the manufacturing efficiency from 15:10 to 15:20 today is shown as an example of the motion picture 114 (in the example shown in FIG. 14, a motion picture indicating an aspect in which a worker performs processing on each of a plurality of products transported at a certain speed by a belt conveyor) a motion picture indicating the manufacturing efficiency of the specific manufacturing process 20A in the time slot from 15:00 to 16:00 yesterday (that is, one day before) is shown as an example of the motion picture 116 (in the example shown in FIG. 14, a motion picture indicating an aspect in which the worker performs processing on each of the plurality of products transported at a certain speed by a belt conveyor).

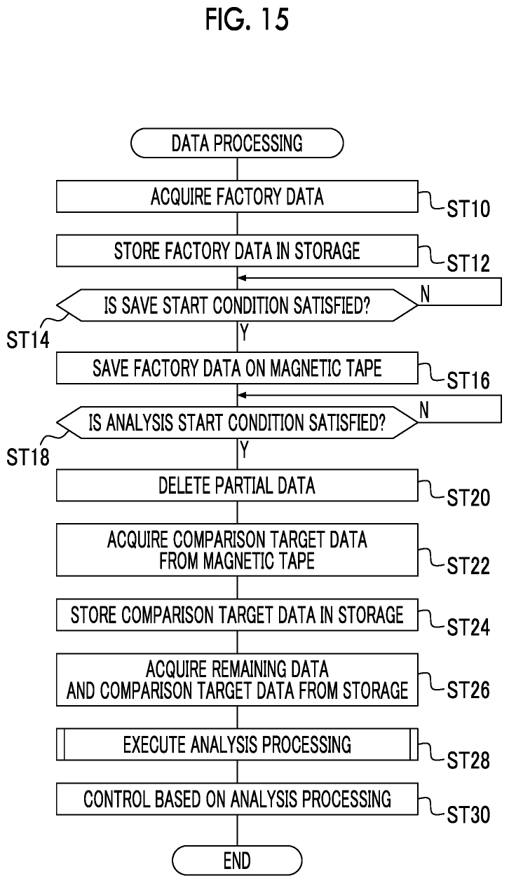

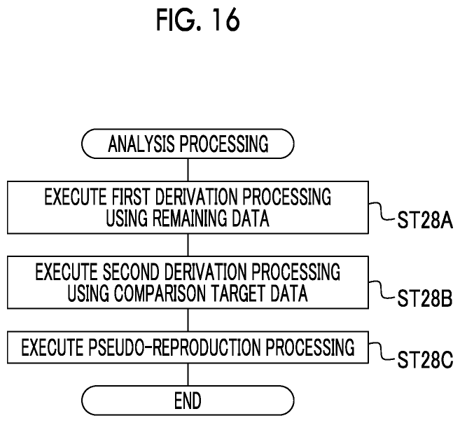

Next, an operation of the data processing system 10 will be described with reference to FIGS. 15 and 16.

FIG. 15 shows an example of a flow of the data processing performed by the processor 54. The flow of the data processing shown in FIG. 15 is an example of a “data processing method” according to the technology of the present disclosure.

In the data processing shown in FIG. 15, first, in step ST10, the acquisition unit 54A acquires the factory data 102 from the factory 20 (see FIG. 8). After the processing of step ST10 is executed, the data processing proceeds to step ST12.

In step ST12, the controller 54B stores the factory data 102 acquired in step ST10 in the storage 56 (see FIG. 8). After the processing of step ST12 is executed, the data processing proceeds to step ST14.

In step ST14, the controller 54B determines whether or not the save start condition is satisfied (see FIG. 9). In step ST14, in a case in which the save start condition is not satisfied, a negative determination is made, and the determination of step ST14 is performed again. In a case in which the save start condition is satisfied in step ST14, a positive determination is made, and the data processing proceeds to step ST16.

In step ST16, the controller 54B causes the magnetic tape management system 16 to save the factory data 102 stored in the storage 56 on the magnetic tape MT (see FIG. 9). After the processing of step ST16 is executed, the data processing proceeds to step ST18. It should be noted that, even in a case in which the processing of step ST16 is executed, the factory data 102 remains in the storage 56 without being deleted.

In step ST18, the controller 54B determines whether or not the analysis start condition is satisfied (see FIG. 10). In step ST18, in a case in which the analysis start condition is not satisfied, a negative determination is made, and the determination of step ST18 is performed again. In a case in which the analysis start condition is satisfied in step ST18, a positive determination is made, and the data processing proceeds to step ST20.

In step ST20, the controller 54B deletes the partial data 102A from the storage 56 (see FIG. 10). After the processing of step ST20 is executed, the data processing proceeds to step ST22.

In step ST22, the controller 54B acquires the comparison target data 108 from the magnetic tape MT (see FIG. 11). After the processing of step ST22 is executed, the data processing proceeds to step ST24.

In step ST24, the controller 54B stores the comparison target data 108 acquired in step ST22 in the storage 56 (see FIG. 11). After the processing of step ST24 is executed, the data processing proceeds to step ST26.

In step ST26, the analysis execution unit 54C acquires the remaining data 102B and the comparison target data 108 from the storage 56. After the processing of step ST26 is executed, the data processing proceeds to step ST28.

In step ST28, the analysis execution unit 54C executes the analysis processing (see FIG. 16). After the processing of step ST28 is executed, the data processing proceeds to step ST30.

In the analysis processing shown in FIG. 16, in step ST28A, the analysis execution unit 54C executes the first derivation processing by using the remaining data 102B acquired in step ST26 (see FIG. 12). After the processing of step ST28A is executed, the analysis processing proceeds to step ST28B.

In step ST28B, the analysis execution unit 54C executes the second derivation processing by using the comparison target data 108 acquired in step ST26 (see FIG. 12). After the processing of step ST28B is executed, the analysis processing proceeds to step ST28C.

In step ST28C, the analysis execution unit 54C executes the pseudo-reproduction processing based on the first behavior data obtained by performing the first derivation processing in step ST28A and the second behavior data obtained by performing the second derivation processing in step ST28B (see FIG. 12). That is, in step ST28C, the pseudo-reproduction is performed in which the behavior indicated by the first behavior data and the behavior indicated by the second behavior data are compared. In a case in which the processing of step ST28C is executed, the analysis processing ends.

In step ST30 shown in FIG. 15, the controller 54B performs a control based on a result of the analysis processing (here, as an example, the pseudo-reproduction result (see FIGS. 13 and 14)). For example, as shown in FIG. 13, the controller 54B visualizes the result of the analysis processing by displaying the graphs 110 and 112 on the display 46 in a comparable state. In addition, for example, as shown in FIG. 14, the controller 54B visualizes the result of the analysis processing by displaying the motion pictures 114 and 116 on the display 46 in a comparable state. After the processing of step ST30 is executed, the data processing ends.

As described above, in the analysis apparatus 14, factory data 102 is acquired from the factory 20, and the acquired factory data 102 is stored in the storage 56. In addition, the analysis apparatus 14 causes the magnetic tape management system to save the factory data 102 stored in the storage 56 on the magnetic tape MT. Then, in the analysis apparatus 14, in a case in which the analysis start condition is satisfied, a part of the factory data 102 is reduced from the storage 56. As a result, it is possible to contribute to securing a free space in the storage 56 as compared with a case in which all the factory data 102 remains in the storage 56.

In addition, in the analysis apparatus 14, the reduction of the partial data 102A from the storage 56 is realized by deleting the partial data 102A from the storage 56. Then, the analysis apparatus 14 performs the analysis processing of analyzing the remaining data 102B that remains by reducing the partial data 102A from the storage 56. As a result, it is possible to reduce a security risk by causing the factory data 102 unnecessary for the analysis processing to remain in the storage 56, as compared with a case in which the factory data 102 unnecessary for the analysis also remains in the storage 56.

In addition, the remaining data 102B is the time-series data obtained from the manufacturing process 20A in time series, and in the analysis processing, the first behavior data indicating the behavior of the time series of the manufacturing process 20A is derived from the remaining data 102B. As a result, it is possible to perform processing using the first behavior data indicating the behavior of the time series of the manufacturing process 20A (for example, the pseudo-reproduction processing shown in FIG. 12).

In addition, in the analysis apparatus 14, the pseudo-reproduction processing using the first behavior data is performed. As a result, it is possible to contribute to grasping the behavior of the time series of the manufacturing process 20A.

In addition, in the analysis apparatus 14, the behavior indicated by the first behavior data based on the remaining data 102B and the behavior indicated by the second behavior data based on the comparison target data 108 are compared and reproduced in a pseudo manner by performing the pseudo-reproduction processing in the same time slot between the present and the past. As a result, it is possible to contribute to grasping the difference in the behavior of the manufacturing process in the same time slot between the present and the past.

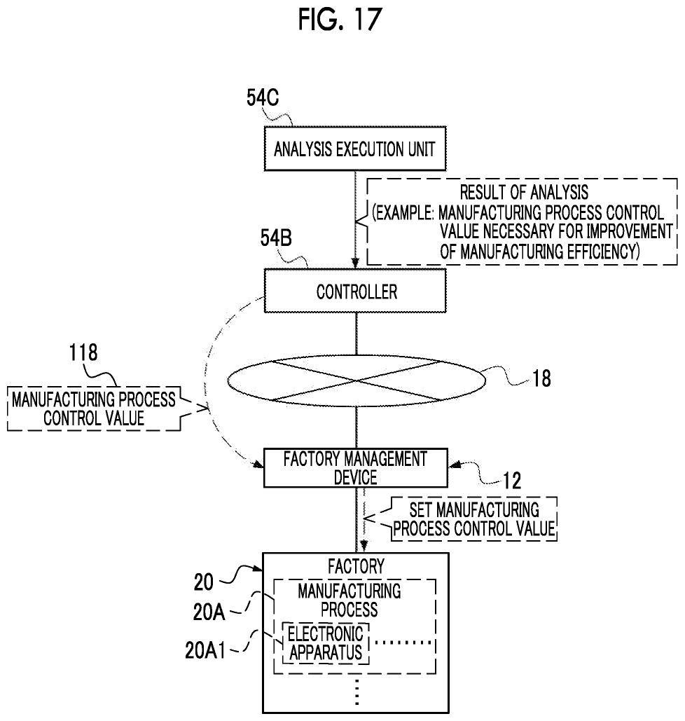

It should be noted that, in the embodiment described above, the form example has been described in which the result of the analysis processing is visualized by being displayed on the display 46 (see FIGS. 13 and 14), but the technology of the present disclosure is not limited to this. For example, the controller 54B may control the manufacturing process 20A based on the analysis result obtained by performing the analysis processing. In this case, as shown in FIG. 17 as an example, the controller 54B acquires a manufacturing process control value 118 necessary for improving the manufacturing efficiency as the analysis result from the analysis execution unit 54C. The manufacturing process control value 118 is, for example, a control value set for at least one electronic apparatus 20A1 included in at least one manufacturing process 20A in order to match or approximate the graph 110 shown in FIG. 13 with the graph 112 (for example, a parameter that controls the electronic apparatus 20A1).

The controller 54B transmits the manufacturing process control value 118 to the factory management device 12 via the network 18. The factory management device 12 receives the manufacturing process control value 118, and sets the received manufacturing process control value 118 in the electronic apparatus 20A1 included in the manufacturing process 20A. As a result, it is possible to contribute to the immediate improvement of the behavior of the manufacturing process 20A. In addition, the behavior of the manufacturing process 20A improved in this way and/or the behavior of at least one electronic apparatus 20A1 included in the improved manufacturing process 20A may be displayed on the display 26 and/or 46 by a graph, a still picture, or a motion picture. The behavior of the manufacturing process 20A before the improvement and/or the behavior of at least one electronic apparatus 20A1 included in the manufacturing process 20A before the improvement and the behavior of the manufacturing process 20A after the improvement and/or the behavior of at least one electronic apparatus 20A1 included in the manufacturing process 20A after the improvement may be displayed in a comparable state by a graph, a still picture, or a motion picture.

Here, the display using the display 26 and/or 46 has been described as an example, but this is merely an example, and the analysis result may be presented by various presentation devices. For example, instead of the display 26 and/or 46, or together with the display 26 and/or 46, the analysis result may be presented by audio output by an audio reproduction device and/or recording on a recording medium (for example, paper) by a printer.

Here, the form example has been described in which the manufacturing process control value 118 is set for the electronic apparatus 20A1 regardless of the magnitude of the difference between the graph 110 and the graph 112, but the technology of the present disclosure is not limited to this. For example, in a case in which a time during which the manufacturing efficiency in a predetermined time slot (for example, the time slot from 15:00 to 16:00) today is less than a target manufacturing efficiency is equal to or longer than a first predetermined time (for example, 50 minutes) and a time during which the past manufacturing efficiency in the same time slot as the today's predetermined time slot is less than the target manufacturing efficiency is shorter than a second predetermined time (for example, 10 minutes) shorter than the first predetermined time, the controller 54B may generate the manufacturing process control value 118 at which the time during which the manufacturing efficiency in the same time slot is less than the target manufacturing efficiency is shorter than the second predetermined time to set the generated manufacturing process control value 118 in the electronic apparatus 20A1. As a result, only because there is the difference between the graph 110 and the graph 112, the frequency at which the controller 54B sets the manufacturing process control value 118 in the electronic apparatus 20A1 can be suppressed than a case in which the controller 54B sets the manufacturing process control value 118 in the electronic apparatus 20A1.

In addition, in the embodiment described above, the manufacturing efficiency in the manufacturing process 20A has been described as an example, but the manufacturing efficiency is merely an example, and a value need only be a value indicating the behavior of at least one manufacturing process 20A and/or at least one electronic apparatus 20A1.

In addition, in the embodiment described above, the analysis processing of comparing the remaining data 102B and the comparison target data 108 has been described as an example, but this is merely an example, and the analysis need only be performed on the remaining data 102B. In addition, in the analysis processing of comparing the remaining data 102B and the comparison target data 108, the comparison target data 108 may be past statistical data. Examples of the past statistical data include average data, median data, and/or mode data indicating the behavior of at least one manufacturing process 20A and/or at least one electronic apparatus 20A1 of a specific time slot (for example, the time slot from 15:00 to 16:00 or a time slot determined in accordance with the command received by the reception device 24 or 44) of days, weeks, months, or years, in the past factory data 102 stored in at least one magnetic tape MT.

In addition, in a case in which the past factory data 102 stored in the magnetic tape MT and the past statistical data are used as the comparison target data 108, the analysis execution unit 54C may analyze the remaining data 102B and the comparison target data 108, or the comparison target data 108 by an artificial intelligence (AI) method to predict the behavior of the factory 20, at least one manufacturing process 20A, and at least one electronic apparatus 20A1, and to calculate the manufacturing process control value 118 based on the predicted behavior.

For example, in a case in which the behavior predicted by the analysis execution unit 54C is not the behavior expected in advance (that is, the ideal behavior), the manufacturing process control value 118 is calculated to match or approximate the behavior expected in advance (that is, the ideal behavior). In a case in which the plurality of manufacturing processes 20A are collectively controlled by the factory management device 12, for example, the manufacturing process control value 118 is calculated for each manufacturing process 20A, and the manufacturing process control value 118 optimized for the plurality of manufacturing processes 20A is calculated (for example, the manufacturing process control value 118 that brings all the manufacturing processes 20A closest to the ideal behavior). In addition, in a case in which the plurality of electronic apparatuses 20A1 are collectively controlled by the factory management device 12, for example, the manufacturing process control value 118 is calculated for each electronic apparatus 20A1, and the manufacturing process control value 118 optimized for the plurality of electronic apparatuses 20A1 is calculated (for example, the manufacturing process control value 118 that brings all the electronic apparatuses 20A1 closest to the ideal behavior).

In addition, the analysis execution unit 54C may calculate the difference between the predicted behavior and the behavior expected in advance (that is, the ideal behavior), instead of the calculation of the manufacturing process control value 118 or together with the calculation of the manufacturing process control value 118. In addition, the remaining data 102A and the comparison target data 108 for the designated time slot, or the comparison target data 108 for the designated time slot may be analyzed by the AI method. It should be noted that the analysis result may be presented by a presentation device (for example, a display, a speaker, and/or a printer) installed in the factory 20 under the control of the factory management device 12. The presented information may be charted information, imaged information (for example, motion picture), or audio information.

In addition, in the embodiment described above, the form example has been described in which the behavior of the manufacturing process 20A in the same time slot having different dates is compared and reproduced in a pseudo manner, but the technology of the present disclosure is not limited to this. The behavior of the manufacturing process 20A in the different time slots (for example, a time slot from 13:00 to 14:00 and a time slot from 16:00 to 17:00) may be compared and reproduced in a pseudo manner. In this case, it is possible to contribute to grasping the difference in the behavior of the manufacturing process 20A in different time slots.

In addition, in the embodiment described above, the smart factory has been described as an example of the factory 20, but the technology of the present disclosure is not limited to this, and a factory other than the smart factory may be used. In addition, it may be a part of the factory 20 or may be a manufacturing site other than the factory 20.

In addition, in the embodiment described above, the factory data 102 has been described as an example, but the technology of the present disclosure is not limited to this. The technology of the present disclosure can be applied to industrial data, such as economic data, population data, infrastructure data, security data, meteorological data, traffic data, building data, manufacturing industry data, and/or medical data (that is, all data about the industry).

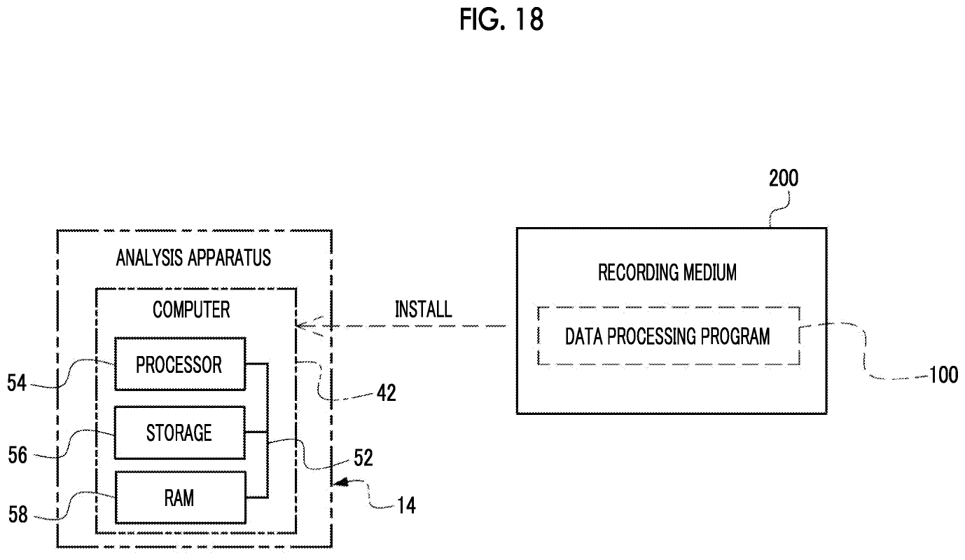

In addition, in the embodiment described above, the form example has been described in which the data processing program 100 is stored in the storage 56, but the technology of the present disclosure is not limited to this. For example, as shown in FIG. 18, the data processing program 100 may be stored in a portable storage medium 200, such as an SSD or a USB memory. The storage medium 200 is a computer-readable non-transitory storage medium. The data processing program 100 stored in the storage medium 200 is installed in the computer 42 of the analysis apparatus 14. The processor 54 executes the data processing in accordance with the data processing program 100.

In addition, the data processing program 100 may be stored in a storage device, such as another computer or server, connected to the analysis apparatus 14 via the network 18 (see FIG. 1), and the data processing program 100 may be downloaded and installed in the computer 42 in response to a request from the analysis apparatus 14.

It is not necessary to store the entire data processing program 100 in the storage device, such as another computer or server connected to the analysis apparatus 14, or the storage 56, and a part of the data processing program 100 may be stored. It should be noted that the storage medium 200, the storage device, such as another computer or server connected to the analysis apparatus 14, and another external storage (for example, a database) are positioned as a memory used by being directly or indirectly connected to the processor 54.

In addition, in the embodiment described above, although the computer 42 has been described as an example, the technology of the present disclosure is not limited to this, and a device including the ASIC, the FPGA, and/or the PLD may be applied instead of the computer. In addition, instead of the computer, the hardware configuration and the software configuration may be used in combination.

The following various processors can be used as the hardware resource for executing the data processing described in the above embodiment. Examples of the processor include the CPU which is a general-purpose processor functioning as the hardware resource for executing the data processing by executing software, that is, a program. In addition, examples of the processor include a dedicated electric circuit which is a processor having a circuit configuration designed to be dedicated to executing specific processing, such as the FPGA, the PLD, or the ASIC. The memory is incorporated in or connected to any processor, and any processor executes the data processing by using the memory.

The hardware resource for executing the data processing may be composed of one of various processors, or may be composed of a combination of two or more processors of the same type or different types (for example, a combination of a plurality of FPGAs or a combination of the CPU and the FPGA). In addition, the hardware resource for executing the data processing may be one processor.

As a configuring example of one processor, first, there is a form in which one processor is composed of a combination of one or more CPUs and software and the processor functions as the hardware resource for executing the data processing. Second, as represented by the SoC or the like, there is a form of using a processor that realizes, by one IC chip, a function of the entire system including a plurality of hardware resources for executing the data processing. As described above, the data processing is realized by using one or more of the various processors as the hardware resources.

Further, as the hardware structure of these various processors, more specifically, it is possible to use an electric circuit in which circuit elements, such as semiconductor elements, are combined. In addition, the data processing is merely an example. Therefore, it is needless to say that the deletion of an unnecessary step, the addition of a new step, and the change of a processing order may be employed within a range not departing from the gist.

The description contents and the shown contents above are the detailed description of the parts according to the technology of the present disclosure, and are merely examples of the technology of the present disclosure. For example, the description of the configuration, the function, the action, and the effect above are the description of examples of the configuration, the function, the action, and the effect of the parts according to the technology of the present disclosure. Accordingly, it is needless to say that unnecessary parts may be deleted, new elements may be added, or replacements may be made with respect to the contents described and shown above within a range that does not deviate from the gist of the technology of the present disclosure. In addition, in order to avoid complications and facilitate understanding of the parts according to the technology of the present disclosure, in the description contents and the shown contents above, the description of common technical knowledge and the like that do not particularly require description for enabling the implementation of the technology of the present disclosure are omitted.

In the present specification, “A and/or B” is synonymous with “at least one of A or B”. That is, “A and/or B” means that it may be only A, only B, or a combination of A and B. In addition, in the present specification, in a case in which three or more matters are associated and expressed by “and/or”, the same concept as “A and/or B” is applied.

All documents, patent applications, and technical standards described in the present specification are incorporated into the present specification by reference to the same extent as in a case in which the individual documents, patent applications, and technical standards are specifically and individually stated to be described by reference.

What is claimed is:

1. A data processing device comprising:
a processor; and
a storage connected to the processor,
wherein the processor
acquires industrial data,
stores the acquired industrial data in the storage,
causes a magnetic tape management system that manages a magnetic tape to save the industrial data stored in the storage on the magnetic tape, and
reduces a part of the industrial data from the storage in a case in which a predetermined condition is satisfied.

2. The data processing device according to claim 1,
wherein the processor
reduces the part of the industrial data from the storage by deleting the part of the industrial data from the storage, and
performs analysis processing of analyzing remaining data that remains in the storage by reducing the part of the industrial data from the storage.

3. The data processing device according to claim 2,
wherein the remaining data is time-series data obtained from a manufacturing process in time series, and
the analysis processing includes derivation processing of deriving behavior data indicating behavior in time series of the manufacturing process from the remaining data.

4. The data processing device according to claim 3,
wherein the processor performs pseudo-reproduction processing of reproducing the behavior in a pseudo manner by using the behavior data derived by the derivation processing.

5. The data processing device according to claim 4,
wherein the pseudo-reproduction processing includes processing of comparing the behavior in the same time slot or different time slots to reproduce the behavior in a pseudo manner.

6. The data processing device according to claim 3,
wherein the processor controls the manufacturing process based on an analysis result obtained by performing the analysis processing.

7. The data processing device according to claim 1,
wherein the predetermined condition includes a condition that save of the industrial data on the magnetic tape is completed.

8. A data processing method comprising:
acquiring industrial data;
storing the acquired industrial data in a storage;
causing a magnetic tape management system that manages a magnetic tape to save the industrial data stored in the storage on the magnetic tape; and
reducing a part of the industrial data from the storage in a case in which a predetermined condition is satisfied.

9. A non-transitory computer-readable storage medium storing a program executable by a computer to perform a process comprising:
acquiring industrial data;
storing the acquired industrial data in a storage;
causing a magnetic tape management system that manages a magnetic tape to save the industrial data stored in the storage on the magnetic tape; and
reducing a part of the industrial data from the storage in a case in which a predetermined condition is satisfied.
